(19) United States
(12) Patent Application Publication
(10) Pub. No.: US 2018/0158376 A1
(43) Pub. Date: Jun. 7, 2018

(54) SYSTEM AND METHOD FOR A WEARABLE MEDICAL SIMULATOR

(71) Applicant: The General Hospital Corporation, Boston, MA (US)

(72) Inventors: Paul TESSIER, Lynnfield, MA (US); Mark P. OTTENSMEYER, Watertown, MA (US); James GORDON, Lexington, MA (US); Biswarup Mukherjee, Cambridge, MA (US)

(21) Appl. No.: 15/577,704

(22) PCT Filed: Jun. 1, 2016
(86) PCT No.: PCT/US16/35307

§ 371 Date: Nov. 28, 2017

Related U.S. Application Data
(60) Provisional application No. 62/169,911, filed on Jun. 2, 2015.

(51) Int. Cl. G09B 23/34

(52) U.S. Cl. CPC G09B 23/34

(57) ABSTRACT

A system and method for providing a medical simulation system that adds high-fidelity features to manikin simulators and standardized patients. The medical simulation system includes wearable components that contain modules for simulating pulses, heart and lung sounds, and breathing motion. The wearable components may be coupled to a vital signs display and may be incorporated into a manikin simulator or worn by a standardized patient. The medical simulation system includes an isolation component that isolates the wearable components from the manikin or standardized patient, and isolates the manikin or standardized patient from the wearable components.

### CROSS-REFERENCE TO RELATED APPLICATIONS

This application claims the benefit of U.S. Provisional Patent Application No. 62/169,911 filed on Jun. 2, 2015, the entire contents of which are incorporated by reference herein.

### STATEMENT REGARDING FEDERALLY SPONSORED RESEARCH

This invention was made with government support under W81XWH-09-2-0001 awarded by the US Army. The government has certain rights in the invention.

### BACKGROUND OF THE DISCLOSURE

Practice is an important element in obtaining experience. Unfortunately, deliberate practice of medical procedures is not easy to obtain due to the intrinsic hazards and complexities of patient care. The use of medical simulation is an alternative to practicing on patients and allows skill development without putting patients at risk.

Medical simulation training is commonly done using standardized patients and manikin-based stimulators. A standardized patient is someone who has been trained to portray, in a consistent, standardized manner, a patient in a medical situation. Manikin-based stimulators are simulators that take the form of a patient body or partial body.

Standardized patients in many ways provide a realistic patient situation for training (e.g., human interaction) but are limited in that the actors cannot arbitrarily change their vital signs (e.g., heart rate, pulse strength, blood pressure, respiration rate) restricting the types of simulation and education that can be done.

Wearable simulation garments are intended to overcome this issue by providing devices with simulated vital signs that can be worn by a standardized patient. Many of the existing publications related to wearable simulation garments describe possible patient parameters that could be simulated but fail to provide any meaningful teaching as to how to accomplish related functionality. Existing wearable simulation garments are inadequate for use in a training environment for at least the following reasons:
1. the parameters provided are not good representations of actual physiology;
2. the real parameters from the standardized patient are not isolated from the simulated parameters compromising the simulation;
3. the simulated parameters are discomforting to the standardized patient (e.g., motion, noise, weight);
4. the components required to be located on the patient are large and/or bulky making them difficult to wear and conceal;
5. power consumption of the system is too high to allow for a body worn battery and could generate uncomfortable heat; and
6. connections are required to non-body worn components that could restrict the movement of the standardized patient and could also result in pinched tubes making the solution inoperable.

It does not appear that a wearable simulation garment has been accepted in the marketplace (or perhaps never even made it to market) likely due to these problems. Therefore it would be desirable to have wearable simulation products that are resolve the unmet needs of users.

There are a variety of manikin-based, both full-body and partial body, medical simulators available for use in both cognitive and procedural training of clinical personnel. These manikin-based medical simulators can be segmented into three categories. Namely, high-fidelity manikin simulators, resuscitation and patient care simulators, and task simulators.

At the high end of the manikin-based stimulator category are high-fidelity manikin simulators including full-body simulators fitted with sensors and actuators to simulate a patient and react to interventions and therapies. The high-fidelity manikin simulators also provide realistic features such as palpable pulses, heart and lung sounds, breathing motion, and a vital signs display. The simulation can be operated by a trainer or utilize physiologic and pharmacologic models to create autonomous reactions. Many of the high-fidelity solutions currently on the market embed most of the support services into the manikin. While this approach allows for a self-contained, highly mobile solution, it tends to result in an expensive solution that is not easily scalable and may be difficult to operate and maintain. As a result, lower-fidelity products and standardized patients are commonly used as a compromise even though higher-fidelity may be desired.

Resuscitation and patient care simulators use a manikin comprised of at least a head and torso up to a full body manikin and are lower-fidelity products targeted at resuscitation and patient care training. These simulators are most commonly used for procedural training, such as basic life support (BLS) training and advanced life support (ALS) training. Most resuscitation and patient care simulators fall into a mid-range of pricing and cost significantly less than high-fidelity manikin simulators.

The category of task simulators includes partial body models that train for a particular task, procedure, or anatomic region of the body. These simulators are typically used for specific procedural training. A majority of task simulators are low priced units, but larger, more capable units can be in the mid-range of pricing.

Organizations providing medical training (e.g., hospitals, medical schools, and nursing schools) frequently have a mix of these manikin-based simulator products and availability of standardized patients to satisfy training needs, which results in significant cost, physical space requirements, and maintenance difficulties. Additionally, there is a large gap in the mid-range of the price and performance curve for medical simulators. Users are often forced to choose between low to mid-priced products focused on procedural training or high-end expensive products focused on cognitive training. There is little compatibility and interoperability between products, and there is limited modularity and configurability of individual products. For example, physical modularity in current products is typically limited to optional limbs (e.g., IV arm, blood pressure arm, trauma limbs, etc.) or interchangeable genitalia. Software modularity, however, is typically focused on providing training scenarios rather than modular software simulation features. As a result, simulators cannot be interchanged or easily configured for different training needs. Therefore, it would be desirable to have an interchangeable, flexible way to add high-fidelity features to a wide range of lower-fidelity products enabling those products to be used for more advanced training.

Another common issue with standardized patient simulation and manikin-based medical simulators is the generation of body sounds, such as heart, lungs, and bowel sounds. Clinicians listen to these sounds through a stethoscope (called auscultation) to determine if a patient's organs are healthy by evaluating frequency, intensity, duration, number, and quality of sounds. Body sounds have been simulated using a variety of techniques including speakers, location-based sound transmission, and remote controlled sound transmission. However, none of these techniques produce a reliable, cost-effective and automatic means of creating realistic body sounds and are not suitable for use in wearable components.

Using speakers in manikin-based simulators involves placing speakers inside a manikin at locations where sounds need to be heard. This technique allows a standard stethoscope to be used for the simulation. However, this approach has many drawbacks and limitations. For example, sound quality can be poor due to resonances and vibrations in the manikin, and the low-end frequency response can be poor due to limited speaker size. In addition, localizing sounds to a particular area of the manikin can be difficult since sounds travel within the manikin. Further, noise from other system components, such as motors and solenoids, can easily be picked up with the stethoscope. In addition, this technique does not transfer well for implementation in a wearable solution for a standardized patient.

Some wearable simulation garments have contemplated embedding speakers. However, speakers of adequate bandwidth to reproduce body sounds tend to be large and bulky making them difficult to conceal and wear. The sound field is difficult to control and it is likely that actual body sounds from the standardized patient would be heard unless there was adequate sound damping material that would make the garment bulky and unrealistic. In addition, sound insulating materials are typically thermal insulators and would make the garment hot and uncomfortable for the standardized patient.

To overcome the drawbacks and limitations of using speakers, techniques such as location-based sound transmission have been used to provide a secondary sound transmission based on stethoscope location. With the location-based sound transmission technique, sensors in the manikin or a wearable simulation garment are activated or read with a special stethoscope which determines where the stethoscope is placed on the manikin or person. Based on the location of the stethoscope, the appropriate sound for that location is sent to the special stethoscope using wired or wireless techniques. Alternatively, a control signal is sent to the special stethoscope indicating which sound recording to play from a list of sounds stored in the stethoscope. A variety of sensors have been used to determine the location of the stethoscope including magnets and relays, RFID elements, and capacitive signal coupling. However, the resolution of location determination is limited by the location technique used and/or the cost of providing high resolution location. Therefore, this situation can result in poor sound localization. In addition, a special stethoscope must be used that is capable of receiving the transmitted sound or control signals which further increases the cost and complexity of the system.

Remote controlled sound transmission is similar to the location-based sound transmission technique, but location is determined by a trainer rather than an automated technology. A trainer observes where the stethoscope has been located by the trainee and selects the appropriate sound to transmit to the stethoscope on a remote control. Similar to the location-based sound transmission, a special stethoscope must be used that is capable of receiving the transmitted sound or control signals. Additionally, this technique requires constant attention from an instructor and prohibits standalone use by a trainee. These issues are the same for manikin or standardized patient usage.

Not only are body sounds important to simulate, but also pulses, breathing and other functions which trainees can observe and feel to simulate interaction with a patient are important for standardized patients and manikin-based simulators. However, the realism, limitations, and cost of these simulated physiological functions varies greatly depending on the particular implementation.

As just described, a patient's pulse is a basic function that is important to simulate in standardized patient simulation or simulator manikin. Checking a pulse is one of the easiest ways to determine if a patient's heart is beating, what the heart rate is, and whether the rate is regular or irregular. Pulses have been simulated using a variety of techniques including bulb and tube, air or fluid pressure, and a solenoid driver. However, none of these techniques produce a reliable, cost-effective, and realistic pulse and are not suitable for use in wearable components for a standardized patient.

The bulb and tube approach entails running a length of flexible tubing, for example silicone tubing, to the pulse points on a manikin. The tubing is connected to an external bulb that a trainer can squeeze which causes the pressure in the tubing to rise and the tube to stretch causing a pulse along the tube. Being manual, this method is prone to human error and poor repeatability.

The air or fluid pressure technique is similar to the bulb and tube method, however the tubing is pulsed with air from a compressor or fluid from a pump. The pulsations are controlled automatically, thus improving reliability and repeatability. However, the compressor or pump adds significant cost, increases power consumption, and can create undesirable noise. In addition, valves need to be used if the different pulse points need to be controlled separately, thereby adding to the cost and complexity of the implementation. There is no place to locate these components in a wearable simulation garment that would be unobtrusive. The components could be located in a separate enclosure, but that implementation would require tubes running from the enclosure to the garment, and could restrict the movement of the standardized patient or result in pinched tubes.

A solenoid driver is an alternative to using tubing to create a pulse using a solenoid mechanism. Energizing the solenoid causes a plunger to push on an element that is meant to simulate a section of an artery. However, the resulting pulse tends to feel artificial due to the rigidity of the simulated artery and/or the vertical movement, rather than a flowing and expanding movement.

Another basic function that is important to simulate in a standardized patient or simulator manikin is the breathing motion of the patient. Clinicians can determine whether a patient is breathing, the rate of breathing, and the depth of breathing by visualizing or feeling motion due to breathing. The most common method of simulating breathing motion is to fill and empty a bladder in the chest of a manikin using an integrated compressor or an external air supply. A compressor is bulky, adds significant cost, increases power consumption, and can create noise. Emptying the bladder is typically done with a bleeder valve which adds more cost. There is no place to locate these components in a wearable simulation garment that would be unobtrusive. The components could be located in a separate enclosure and utilize tubes running from the enclosure to the garment. Connected tubes could restrict the movement of the standardized patient and could result in pinched tubes making the solution inoperable. Additionally, isolating the breathing motion of the standardized patient is not possible with current solutions. Therefore, there is a need for a technique for creating chest motion using a different method.

Accordingly, none of the above described techniques produce a reliable, cost-effective and automatic means of creating realistic simulation parameters (e.g., body sounds, pulses, and breathing motions) to add high-fidelity features to lower fidelity manikin simulators and to standardized patients.

There are many low-fidelity manikin simulators (e.g., CPR manikins) in institutions that could be used for more advanced training with the addition of some high-fidelity features. Standardized patients provide a realistic patient situation for training, but are limited in that the actors cannot arbitrarily change their vital signs (e.g., heart rate, pulse strength, blood pressure, respiration rate). There is a need for a simulation system with wearable components that contains features for simulating pulses, heart and lung sounds, and breathing motion coupled to a vital signs display that could be put on a low-fidelity manikin simulator or worn by a standardized patient, which would provide the desired functionality.

### SUMMARY OF THE DISCLOSURE

The present disclosure overcomes the aforementioned drawbacks by providing a medical simulation system with wearable components that contains features for simulating pulses, heart and lung sounds, and breathing motion coupled to a vital signs display that may be put on a manikin-based simulator or worn by a standardized patient.

In accordance with one aspect of the disclosure, a medical simulation system includes at least one wearable component, an interface module coupled to the at least one wearable component and including an interface processor. At least one hardware module is coupled to the interface module, and includes a processor in communication with the interface processor to provide functionality to the at least one wearable component. The at least one hardware modules simulates at least one vital sign. An isolation component is configured to be arranged between the at least one wearable component and a standardized patient to isolate the standardized patient from the wearable component and to isolate the wearable component from the standardized patient.

In accordance with another aspect of the disclosure, a method of providing medical training is disclosed. The method includes providing at least one wearable component and providing an interface module coupled to the at least one wearable component, which may also be worn. The interface module includes an interface processor. At least one hardware module is coupled to the interface module. The at least one hardware module includes a processor in communication with the interface processor to provide functionality to the at least one wearable component. At least one vital sign is simulated by the at least one hardware module when the at least one wearable component is worn by a standardized patient, such simulated vital sign being isolated from the standardized patient to inhibit interaction with the actual vital sign of the standardized patient and to minimize distraction and discomfort of the standardized patient.

The foregoing and other aspects and advantages of the disclosure will appear from the following description. In the description, reference is made to the accompanying drawings which form a part hereof, and in which there is shown by way of illustration a preferred embodiment of the disclosure. Such embodiment does not necessarily represent the full scope of the disclosure, however, and reference is made therefore to the claims and herein for interpreting the scope of the disclosure.

### BRIEF DESCRIPTION OF THE DRAWINGS

FIG. 1 is a schematic view of a medical simulation system including wearable components according to one embodiment of the disclosure.

FIG. 2 is a schematic view of an interface module of the medical simulation system of FIG. 1.

FIG. 3 is a schematic view of one embodiment of a hardware module in the form of a pulse module including a pulse assembly for use in the medical simulation system of FIG. 1.

FIG. 4 is a side view of the pulse assembly of FIG. 3.

FIG. 5 is a top view of the pulse assembly of FIG. 3.

FIG. 6 is a graph representing force curves showing the efficiency of solenoids over various length strokes.

FIG. 7 is a cross sectional view of another pulse assembly that can be used with the medical simulation system of FIG. 1.

FIG. 8 is a schematic view of the pulse assembly of FIG. 7.

FIG. 9A is a flow chart of an algorithm used by the pulse assembly of FIG. 7.

FIG. 9B is a graph charting pressure versus time during the algorithm shown in FIG. 9A.

FIG. 10 is a perspective view of the pulse assembly of FIG. 7.

FIG. 11 is another perspective view of the pulse assembly of FIG. 7.

FIG. 12 is a schematic diagram of one embodiment of a hardware module in the form of a body sound simulator for use in the medical simulation system of FIG. 1.

FIG. 13 is a graph displaying a flux density generated by a source coil of a body sound simulator relative to a pick-up coil.

FIG. 14 is a graph displaying a flux density generated by a source coil of a body sound simulator relative to a pick-up coil.

FIG. 15 a schematic view of one embodiment of a sound module for use in the medical simulation system of FIG. 1.

FIG. 16 a schematic view of one embodiment of a stethoscope module for use in the medical simulation system of FIG. 1.

FIG. 17 is a schematic view of one embodiment of a hardware module in the form of a breathing module including a breathing mechanism for use in the medical simulation system of FIG. 1.

FIG. 18 is a side view of the breathing mechanism of FIG. 17.

FIG. 19 is a front view of a wearable simulation garment that includes an isolation component.

FIG. 20 is a front view of another wearable simulation garment that includes an isolation component.

FIG. 21 is a top view of a ventilation system of a wearable simulation garment.

FIG. 22 is a cross sectional view of a wearable simulation garment including an isolation component.

FIG. 23 is a perspective view of the wearable simulation component of FIG. 22.

FIG. 24 is a perspective view of wearable components implemented as a body suit according to one embodiment of the disclosure.

FIG. 25 is a perspective view of wearable components implemented as a arm cuffs and a chest plate according to one embodiment of the disclosure.

### DETAILED DESCRIPTION OF THE DISCLOSURE

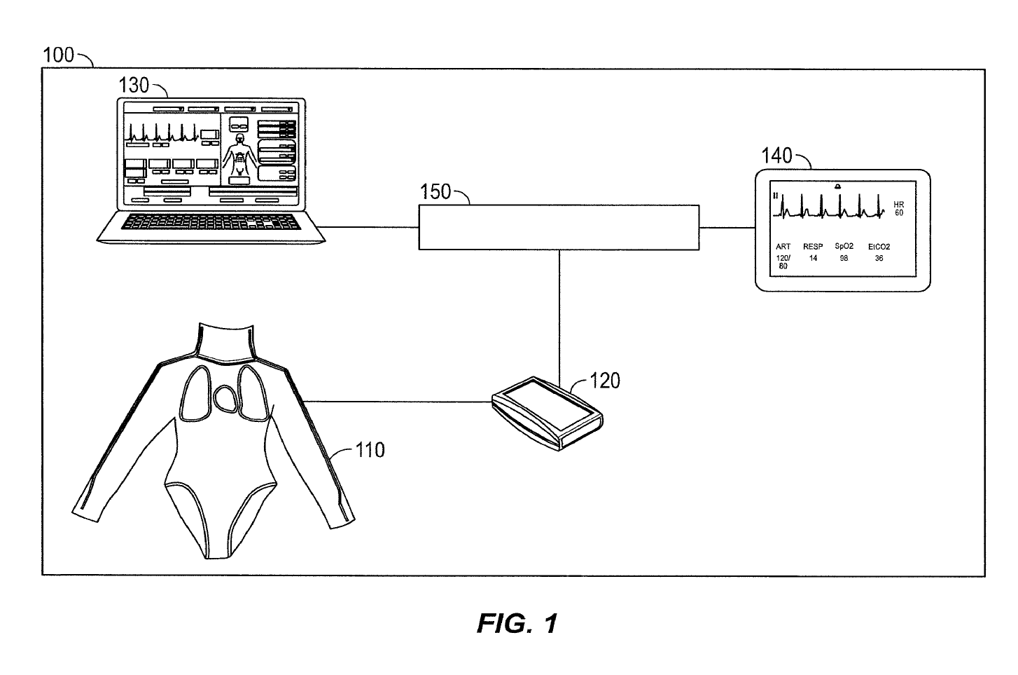

As shown in FIG. 1, a medical simulation system 100 with wearable components 110 includes an interface module 120, a control panel 130, a vital signs display 140 and a network device 150. The interface module 120 may operate the simulation features in the wearable components 110 and may be integrated into the wearable components 110. The interface module 120, control panel 130, and vital signs display 140 may communicate through the network device 150. The network device 150 may also provide data communication to other devices that are real or simulated (e.g. a medical device, a data storage function, an electronic medical record, learning management, or audio video recording). The network device 150 may include a wireless network (e.g., 802.11, 802.15) or a wired network (e.g., Ethernet, USB) suitable for data communication. Simulation information may be presented to a trainee on the vital signs display 140. The vital signs display 140 may mimic a conventional patient monitor display for communication of vital signs and patient status, for example. The vital signs display 140 may be configured to provide vital signs to the user that includes, but is not limited to, waveforms, such as ECG traces, arterial blood pressure (ABP) traces, pulmonary artery pressure (PAP) traces, and pleth (pulse) traces. The vital signs display 140 may also be configured to provide numerical vital signs including, but not limited to, heart rate, systolic and diastolic blood pressure, respiration rate, SpO₂ value, pulmonary artery pressure (PAP), central venous pressure (CVP), pulmonary capillary wedge pressure (PCWP), and EtCO₂. Additionally, the vital signs display 140 may be configured to provide audible sounds to the user, such as a QRS beep, a SpO₂ tone, and an alarm tone. The control panel 130 and the vital signs display 140 may be real, tangible devices or virtual/simulated devices.

Controls to operate the system 100 may be provided to a trainer on the control panel 130. The control panel 130 may be implemented on a laptop, tablet, Smartphone or any other suitable computing device. The medical simulation system 100 may be operated without use of the vital signs display 140 if the training scenario does not require it. Operation of the medical simulation system 100 may be controlled autonomously by the interface module 120 without the use of the control panel 130 or functionality of the interface module 120 may be incorporated into the control panel 130. The functionality of the interface module 120 may also be integrated into the wearable components 110. The wearable components 110 may be put on a manikin or worn by a standardized patient, for example.

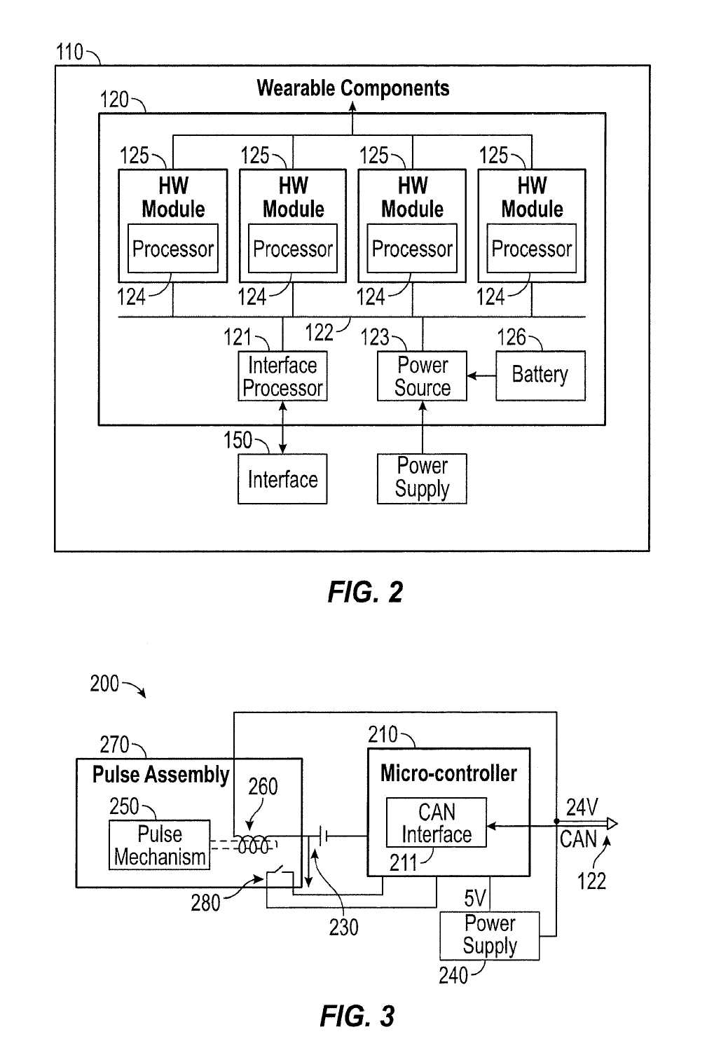

As shown in FIG. 2, the interface module 120 may include an interface processor 121 that communicates between the network device 150 and a communication bus in the form of a communication/power bus 122. The communication/power bus 122 may provide power to the components and communication between hardware modules 125 and the interface processor 121. Each hardware module 125 may include a hardware processor 124 that communicates with the interface processor 121 and provides other processing for the hardware module 125. In one non-limiting example, the functionality provided by and/or the hardware associated with the interface processor 121 and the hardware processors 124 may be implemented using a single processor, a single microcontroller, a single piece of hardware, or a different arrangement of multiple processors, as desired. When implemented on a single processor or a different arrangement of multiple processors, the functionality of interface processor 121 and the hardware processors 124 in the hardware modules 125 or multiple hardware modules 125 that are combined may be program elements operating in a combined processor and the communications portion of the communication/power bus 122 may be accomplished by information sharing of the program elements. Thus, functionality of the interface processor 121, the hardware processors 124 in the hardware modules 125, and the communications portion of the communication/power bus 122 may be physical components, program elements running in a processor, or a combination thereof.

As also shown in FIG. 2, the communications portion of the communication/power bus 122 may be a controller area network (CAN) interface. However, the communications portion of the communication/power bus 122 may be any parallel or serial digital communication technique, may be wired or wireless, and may be a multi-drop bus. As described above, the communications portion of the communication/power bus 122 may be at least partially implemented as a program element running on a processor. The interface module 120 may further include a power source 123 that receives power from a battery 126 or external power supply and provides power to the components over the power portion of the communication/power bus 122. The battery 126 may be a single battery powering all components of the interface module 120, or may be individual batteries powering each hardware module 125 or a group of modules. In this embodiment, each hardware module 125 may provide a feature for the wearable components 110. In one non-limiting example, features may be combined in a hardware module 125 if desired or otherwise distributed including, without limitation, incorporation into the wearable components 110.

The hardware module 125 is intended to simulate a vital sign of a patient. A vital sign being any physiological characteristic or parameter of a human being. In one non-limiting example, the hardware module 125 may be a small, low-cost, energy efficient module interfaced with the wearable components 110 to create a realistic pulse. In another non-limiting example, the hardware module 125 may be a body sound module

capable of generating realistic, localized body sounds in cooperation with the wearable components 110 that is small, flexible, low-cost, and energy efficient.

As shown in FIG. 3, a pulse module 200 for use in medical simulation system 100 may include a microcontroller 210 that has an embedded communication interface 211, such as a CAN interface, that communicates over the communication/power bus 122. A power supply 240 regulates the voltage supplied by the communication/power bus 122 (e.g., 24V) to the voltage required for the microcontroller 210 (e.g., 5V). In response to commands received over the communication interface 211, the microcontroller 210 drives a transistor 230 to actuate a pulse assembly 270. The pulse assembly 270 contains a solenoid 260 that actuates the pulse mechanism 250 which in turn generates a palpable pulse. A touch detector 280 is used to determine when a trainee interacts with the pulse assembly 270 allowing the microcontroller 210 to only actuate the pulse mechanism 250 when needed thereby reducing power consumption, heat, and vibration making the device more comfortable for the person wearing the device and allowing for a smaller power supply and/or battery. The touch detector 280 may be a capacitive touch sensor, a pressure sensitive sheet, a force sensitive resistor or other detector capable of determining touch.

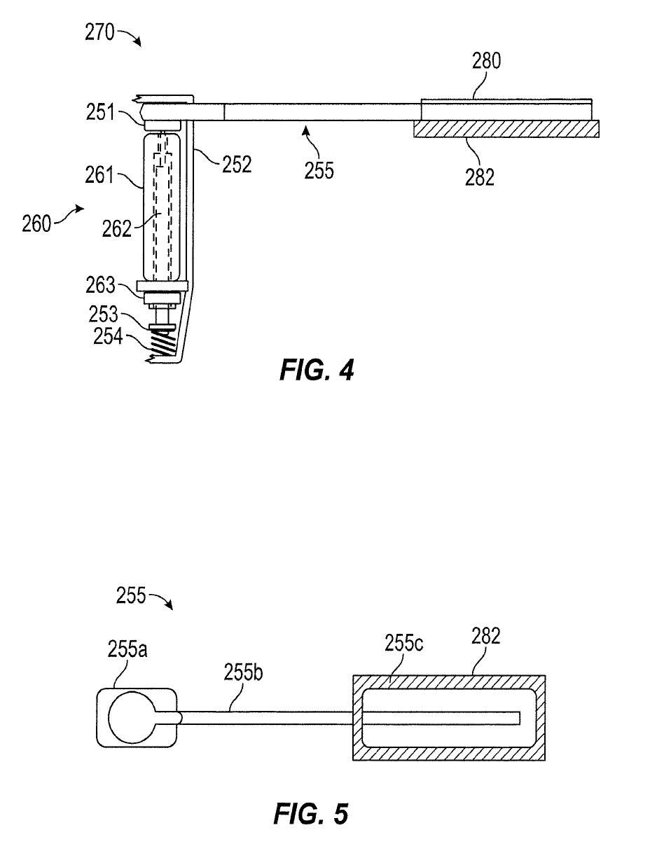

As shown in FIGS. 4 and 5, the solenoid 260 includes a solenoid body 261 that is attached to a frame 252 with a nut 263. An actuator 251 passes through an opening in the base of solenoid body 261. The length of the actuator 251 is such that it positions a plunger 262 a short distance from the bottom of the solenoid body 261 when the actuator 251 is against the base of solenoid body 261. A bladder 255 including a first bladder section 255a, a second bladder section 255b, and a third bladder section 255c passes through an opening near the end of the frame 252 where the first bladder section 255a rests between the end of the frame 252 and the actuator 251.

The bladder sections 255a and 255c may be constructed of a flexible plastic material and contain a cavity that is partially filled with a fluid, such as water or low-viscosity silicone oil, so that the cavity is partially collapsed and is mostly free from air pockets. The plastic used to construct bladder sections 255a and 255c is compliant and easily flexes/collapses, but has limited elasticity. The second bladder section 255b may include a tube that connects the first bladder section 255a and the third bladder section 255c. The second bladder section 255b may be flexible, but does not easily collapse and has limited elasticity. Pressing on the first bladder section 255a may cause the fluid to move through second bladder section 255b to expand the partially collapsed bladder in the third bladder section 255c.

When the solenoid 260 is energized, the plunger 262 exerts a force on the actuator 251 causing the actuator 251 to compress the circular area of the first bladder section 255a which forces fluid through the second bladder section 255b to move into and expand the tubular area of the third bladder section 255c. This motion creates the feeling of a pulse on a trainee's finger placed on the tubular area of third bladder section 255c. When the solenoid 260 is de-energized, the fluid returns to the first bladder section 255a due to forces from the bladder, gravity, and/or the trainee's finger pressure. To inhibit noise from the plunger 262 knocking into the actuator 251, the two parts are held in contact with a light spring force. A snap ring 253 fits within a groove near the end of the plunger 262 and a small spring 254 is placed over the end of the plunger 262 and rests against the snap ring 253 and the end of the frame 252.

The second bladder section 255b can be of varying length allowing the third bladder section 255c to be placed at an appropriate pulse location in the wearable components 110. If individual control of pulse locations is not required, additional bladder sections 255b and 255c can be daisy chained on the bladder assembly 255 thereby creating multiple pulse locations with one pulse module. In one non-limiting example, the components of the pulse module 200 can be located in the interface module 120 with the exception of the second bladder section 255b and the third bladder section 255c, which may be located in the wearable components 110.

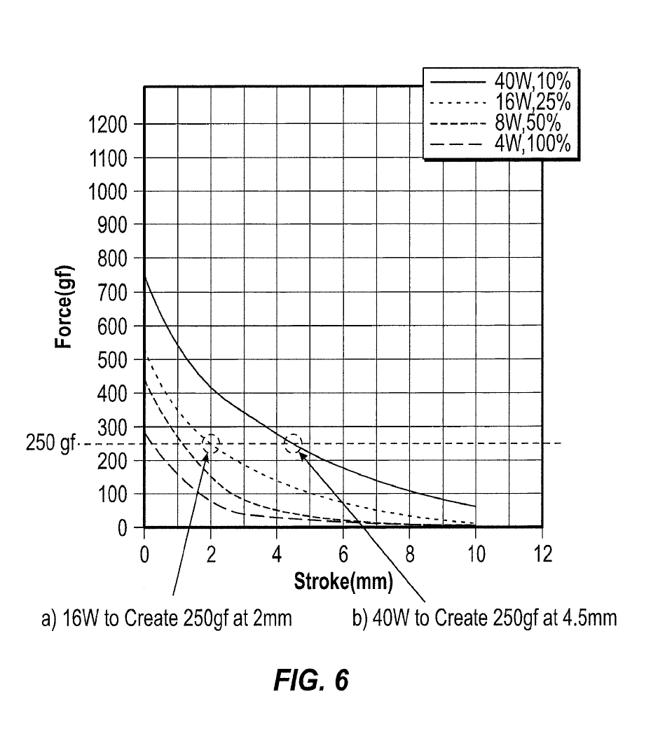

Using a compliant/flexible bladder that is partially filled with fluid provides for an energy efficient design, such that energy is not used to stretch an elastic material such as occurs with techniques that use silicone tubing or bladders. Therefore, the solenoid 260 can be used in a more efficient range of motion since the stroke required is short. Typically, solenoids are inefficient at long strokes as shown the graph in FIG. 6. Using a non-compressible fluid versus a gas allows for a design with a short stroke and is thus more efficient. This design also creates a more realistic feeling pulse than designs that use a solenoid to push on a solid/firm mechanical element. The fluid-filled, compliant tubing feels more like an actual artery. In addition the solenoid 260 can be driven with a pulse-width modulated signal to shape the force curve to better simulate a pulse. Since the module is operated by a microcontroller, the module can automatically adjust the shape of the force curve without burdening the control panel or other system resources.

When the pulse assembly 270 is used with a standardized patient, the third bladder section 255c is placed over the standardized patient's natural pulse location. To inhibit the trainee from feeling the standardized patient's natural pulse and thereby introducing confusion, an isolation component 282 is placed between the third bladder section 255c and the standardized patient's natural pulse location. The isolation component 282 also serves to isolate the pulse created by pulse assembly 270 from startling the standardized patient and in doing so making the system more comfortable for the standardized patient. The isolation component 282 may be in the form of a slight arch that rises above the standardized patient's natural pulse location. An arch shape may also allow air to flow under isolation component 282 providing cooling and added comfort for the standardized patient.

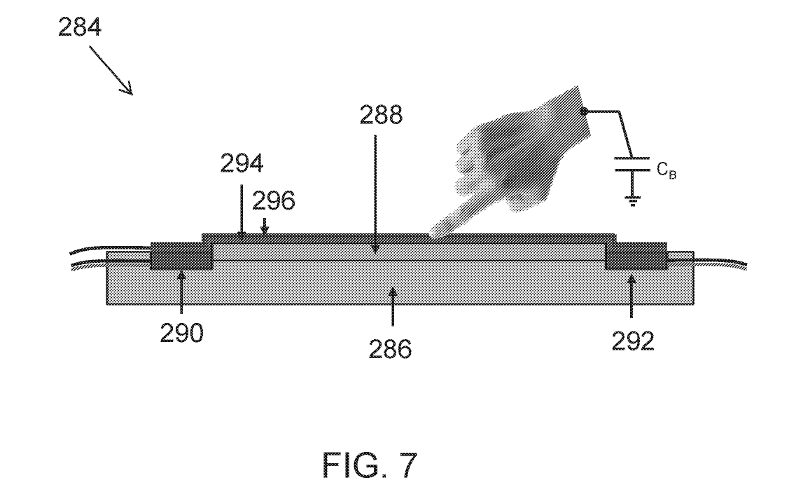

As shown in FIGS. 7-11, a vibrating pulse assembly 284 may be used in addition to or as an alternative to the pulse assembly 270 discussed above. The vibrating pulse assembly 284 may include a compliant material in the form of a soft foam base 286, a dummy tube 288 embedded in the soft foam base 286, a first vibration motor 290, a second vibration motor 292, a conductor sheet 294 coupled between the first vibration motor 290 and the second vibration motor 292, and an insulator sheet 296 covering the conductor sheet 294. One objective of the vibration pulse assembly 284 is to provide a low-cost, low-power pulse simulator with a small footprint capable of being installed at critical sites such as radial, brachial, carotid and femoral in manikins and wearable simulation garments. The vibration pulse assembly 284 could be utilized in the wearable components 110 to augment the experience with standardized patients by providing abnormal palpable pulses, arrhythmias etc. while the standardized patient provides interactivity and simulates additional behaviors.

As shown in FIG. 7, the two vibration motors 290, 292 are embedded on either ends of the soft foam base 286. In other embodiments, a single vibration motor or a multitude of vibration motors may be used. The soft foam base 286 is recessed to accommodate the dummy tube 288 to simulate the underlying structure of an artery. The structure of the arterial dummy tube 288 can be arbitrarily complex. The vibration motors 290, 292 need not be in direct contact with the dummy tube 288. The vibration motors 290, 292 and the dummy tube 288 are covered with the metal conductor sheet 294 and the insulation layer 296 which operate as a touch sensor. Alternatively, the touch sensor can be replaced with a pressure sensitive sheet, a force sensitive resistor, or other mechanism capable of detecting touch.

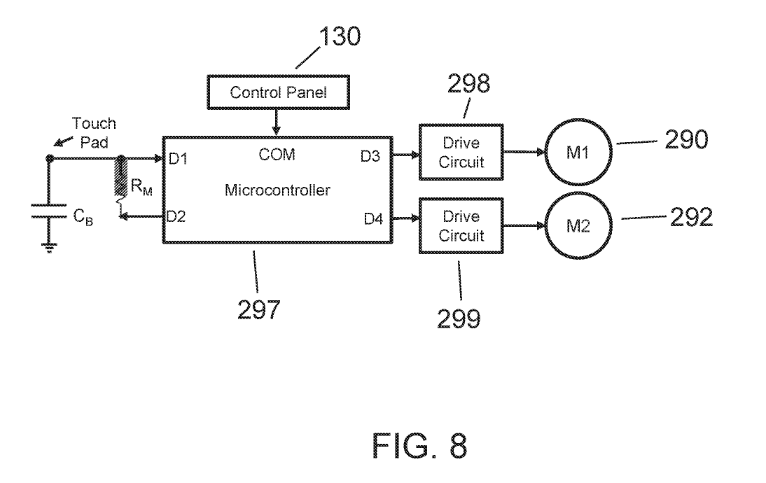

When the trainee's finger comes in contact with the touch pad, a capacitance C_{B} is introduced as shown in FIG. 7 and FIG. 8. As shown in FIG. 8, the vibration pulse assembly 284 also includes a microcontroller 297 that includes a first terminal D1, a second terminal D2, a third terminal D3 and a fourth terminal D4. The microcontroller applies a known DC voltage at terminal D2 to charge the capacitor C_{B} through a fixed measurement resistor R_{M} and the voltage at the terminal D1 is monitored by the microcontroller 297. The rate of increase of the voltage (time constant) at terminal D1 is determined by the body capacitance, C_{B} and measurement resistor R_{M}. R_{M} is a fixed resistor, and C_{B} can be measured by measuring the time required for the voltage at D1 to rise to a pre-selected threshold. The value of the capacitance C_{B} depends on, among other things, the overlap area and the distance between the trainee's finger and the conductor sheet 294. C_{B} increases as the finger is brought closer to the insulator sheet 296 and the conductor sheet 294 or the fingers are pressed harder on it (due to increase in overlapping area). The proximity of the trainee's finger to the touchpad or insulator sheet 296 and the conductor sheet 294 and the approximate pressure exerted by the fingers on the touch pad or insulator sheet 296 and the conductor sheet 294 can be detected by measuring the voltage at terminal D2.

When the voltage at terminal D2 exceeds a pre-set threshold (L_{T}) indicating the trainee's fingers are correctly positioned on the vibrating pulse assembly 284, the microcontroller 297 activates the vibration motors 290 and 292 by supplying pulse width modulated (PWM) signals at terminals D3 and D4 respectively. The PWM signals are fed to a first drive circuit 298 and a second drive circuit 299 to independently control the intensity of vibration of each vibration motor 290, 292. The signals drive the vibration motors 290, 292 causing resultant vibration of the soft foam base 286 and the dummy tube 288 and the vibrations are felt at the trainee's finger. The vibration motors 290, 292 are stopped if the voltage at D2 drops below L_{T} or the voltage exceeds a pre-defined upper threshold U_{T}, indicating that enough pressure is being applied on the dummy tube 288 to occlude it.

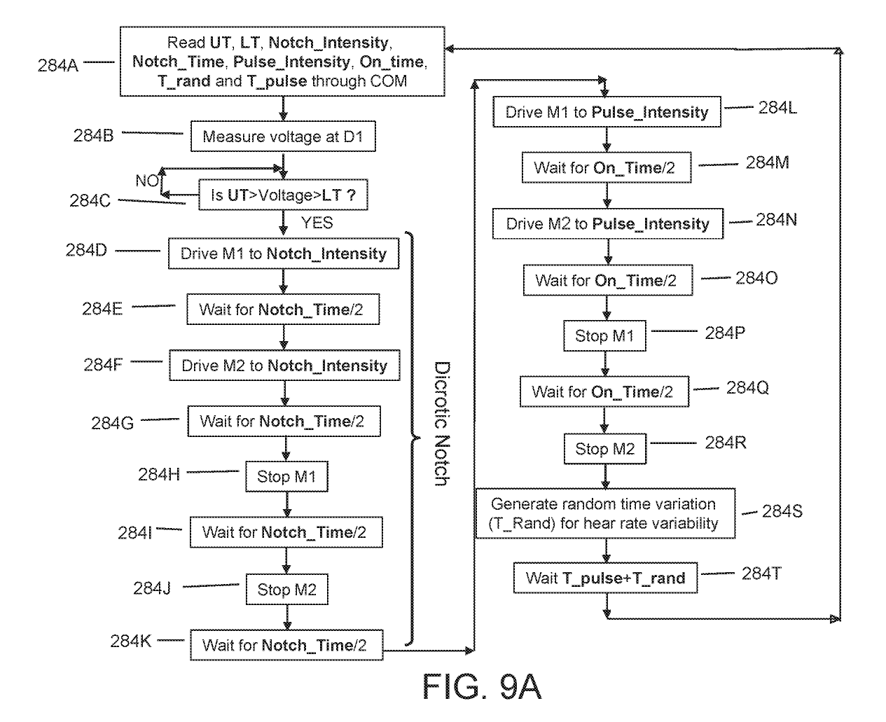

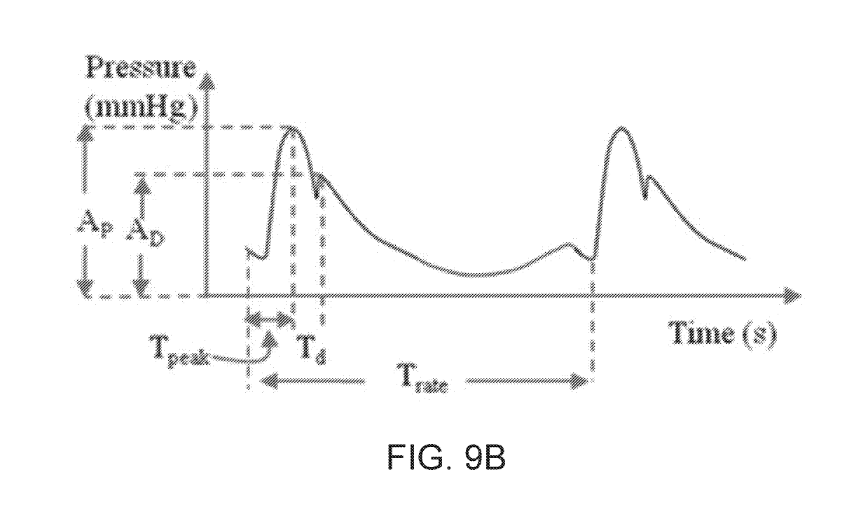

In order to produce a vibration that feels like a human pulse, the vibration motors 290, 292 are activated for a period of time (e.g., 10 ms to 50 ms) depending on the type and size of the vibration motor used. An algorithm for exciting the pulse module is shown in FIG. 9A. The microcontroller 297 accepts the excitation parameters as input through a COM (communication) port of the microcontroller 297 at block 284A via communication/power bus 122 The parameters accepted as input include the upper and lower detection thresholds for the touch/pressure sensor (UT and LT), the position and intensity of the dicrotic notch relative to the total pulse intensity (notch time and notch intensity), total pulse intensity (pulse intensity), duration for motor excitation (on time), pulse rate variability (T_rand) and pulse rate (T_pulse). These parameters can be changed in real-time from the control panel via the communication link and/or the values may be pre-loaded to a microcontroller memory. Control parameters may also be added or removed without altering the functionality of the device.

On receiving the parameters at block 284A, the voltage at terminal D2 is measured at block 284B and compared to the upper and lower thresholds L_{T} and U_{T} at block 284C. The vibration motors 290, 292 are driven only if the voltage at D2 is within the U_{T} and L_{T} thresholds signifying that the dummy tube 288 has been touched but has not been occluded. The vibration motors 290, 292 are driven one after the other, staggered in time, to produce a sensation of a travelling wave between the two vibration motors 290, 292. The first vibration motor 290 is first driven to the notch intensity value, which is lower than the total pulse intensity, at block 284D to simulate the effect of dicrotic notch. The first vibration motor 290 is driven at the notch intensity value for a notch time at block 284E. The second vibration motor 292 is then driven at the notch intensity at block 284F for the notch time at block 284G. The first vibration motor 290 is stopped at block 284H after the notch time has passed, then after another notch time has passed at block 284I, the second vibration motor 292 is stopped at block 284J. After one more notch time delay at block 284K, the dicrotic notch section of the algorithm is complete.

Subsequently, both the vibration motors 290, 292 are driven to the full pulse intensity desired for a specific time (on time). The value of on time is determined experimentally (typically in the range of 10 ms to 50 ms) for each vibration motor 290, 292 to provide a realistic tactile pulse sensation. After the dicrotic notch section, the first vibration motor 290 is driven at the pulse intensity at block 284L for the on time at block 284M. The second vibration motor 292 is then driven at the pulse intensity at block 284N for the on time at block 284O. The first vibration motor 290 is then stopped at block 284P followed by another delay of the on time at block 284Q. Then the second vibration motor 292 is stopped at block 284R.

An appropriate delay is then introduced at block 284S to account for the pulse rate set by the trainer and a small random time-period is added at block 284T to this time period to simulate heart rate variability.

The device can be set-up to simulate any pulse shape or abnormality by setting appropriate values for the parameters mentioned. For example, the result of one exemplary pulse shape is shown in FIG. 9B. Additional parameters can be added to simulate more complex waveforms as well.

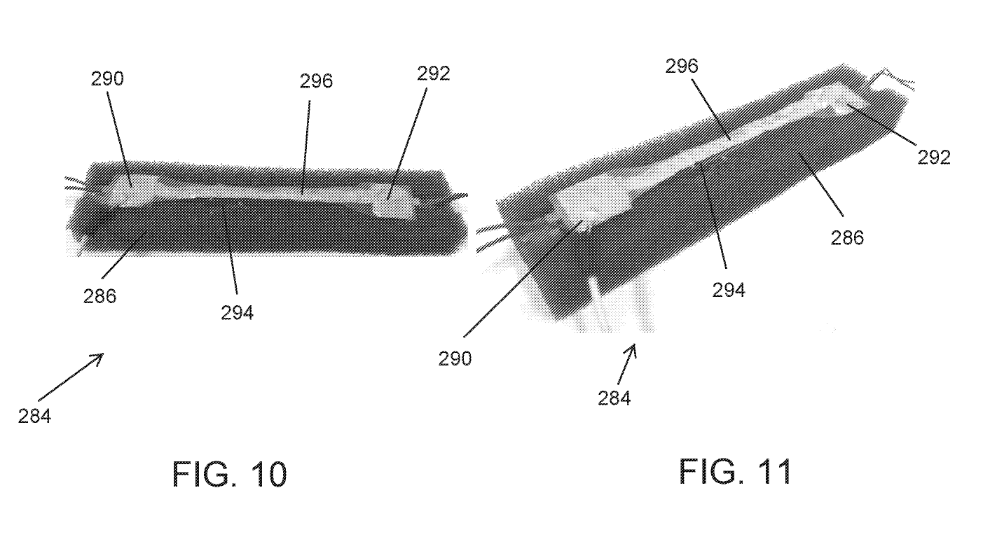

FIGS. 10 and 11 illustrate a prototype vibration pulse assembly 284 that has been developed. The illustrated vibration motors 290, 292 may be coin-type eccentric mass vibration motors or other suitable vibration motor. The conductor sheet 294 may include a copper sheet, and the insulator sheet 296 may include a transparent insulation layer. The conductor sheet 294 and insulator sheet 296 form the touch sensor and conceal the underlying dummy tube 288. The drive circuits 298, 299 may include an NPN transistor in an emitter-follower configuration with a flyback diode connected across the motor to prevent back-EMF. In order to increase the sensitivity of the touch sensor R_{M} may be chosen to be of a high value (10 MΩ). However, due to the high value of R_{M}, the touch measurement is slow, typically 20 ms for C_{B}=200 pF.

In tests, the prototype vibration pulse assembly 284 consumes approximately 40 mW power with a 5V excitation at a pulse rate of 60 bpm at full pulse intensity. Due to the low power consumption and no heat dissipation it is well suited to battery operated applications. The soft foam base 286 reduces noise produced by the vibration motors 290, 292 and minimizes vibrations that are transmitted to the wearable component 110. The small size allows the prototype vibration pulse assembly 284 to be easily retrofitted to low-fidelity manikins and used as a wearable unit on standardized patients.

The device can be set-up to simulate any pulse shape or abnormality by setting appropriate values for the parameters mentioned. Additional parameters can be added to simulate more complex waveforms as well.

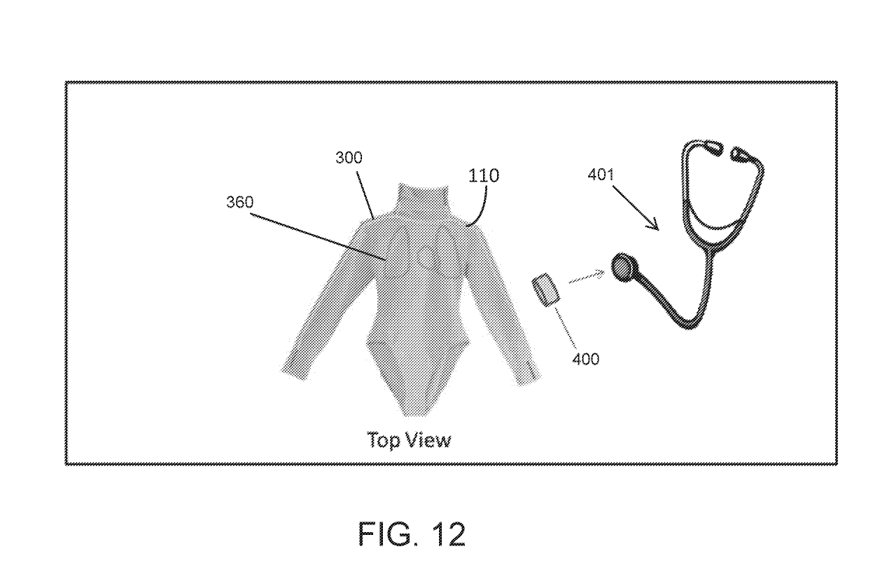

Turning now to FIG. 12, a diagram of another embodiment of a hardware module 125, in the form of a body sound simulator module 300 for use in the medical simulation system 100 is shown. The sound module 300 contains source coils 360 that approximate the outline of the lungs and heart that are placed on the wearable components 110. The source coils 360 are driven with audio signals of lung and heart sounds by the sound module 300, which may be a type of hardware module 125. A small electronic device, such as a stethoscope module 400 containing a coil, picks up the signals through magnetic coupling when the device is placed in the appropriate locations on the wearable components 110. The magnetically coupled signal is amplified and used to drive a small speaker in the stethoscope module 400. The stethoscope module 400 may be attached to the bell of a stethoscope 401 which transmits the sound from the stethoscope module 400 to the trainee.

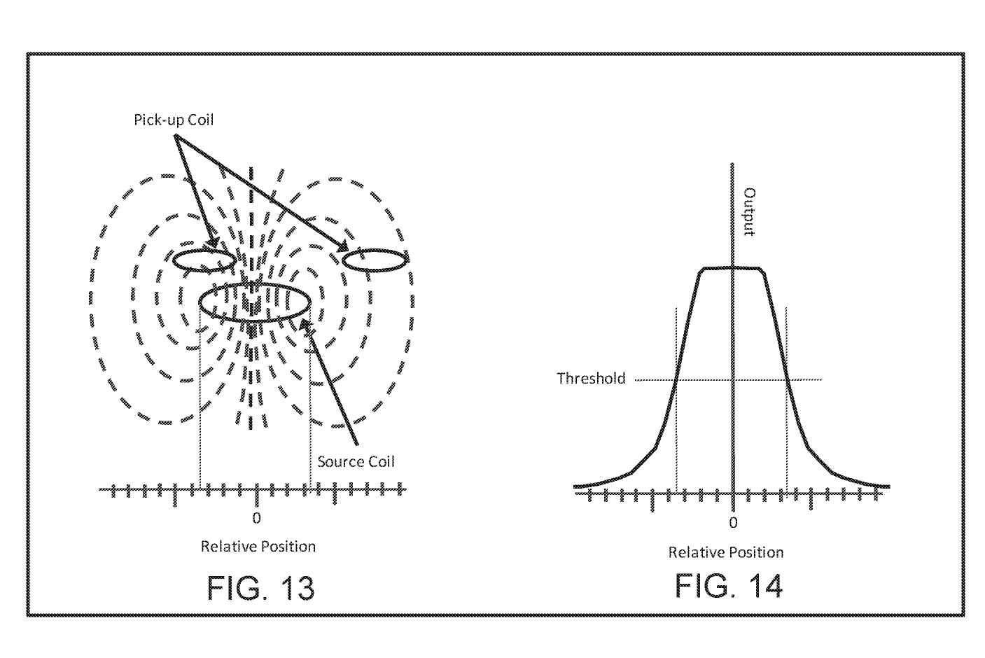

The flux density generated by the source coil 360 is higher inside the coil than a distance outside the coil as shown in FIGS. 13 and 14. A pick-up coil located near the source coil 360 will produce a larger signal as the pick-up coil is moved closer to the source coil 360. Once the leading edge of the pick-up coil crosses the outside edge of the source coil 360, the output signal from the pick-up coil increases quickly and reaches a peak that is maintained until the pick-up coil passes the far edge of the source coil 360. A trainee listening through the stethoscope 401 that is attached to the stethoscope module 400 will hear the appropriate sounds as the stethoscope 401 is moved around the surface of the wearable components 110.

Referring back to FIG. 12, the source coils 360 can be constructed of copper magnet wire, for example, that can be formed in the shape of organs, such as the heart or lungs, creating a realistic sound field. The source coils 360 can also be nested (i.e., placed inside of one another) allowing multiple sounds to be combined. For example, a coil in the shape of a heart could be used to create generic heart sounds and a smaller coil placed inside the heart coil could be used to create a localized and specific valve sound. Source coils 360 may also conform to the body of a standardized patient or the shape of a manikin allowing for a more realistic simulation and in the case of a standardized patient greater comfort than alternative solutions.

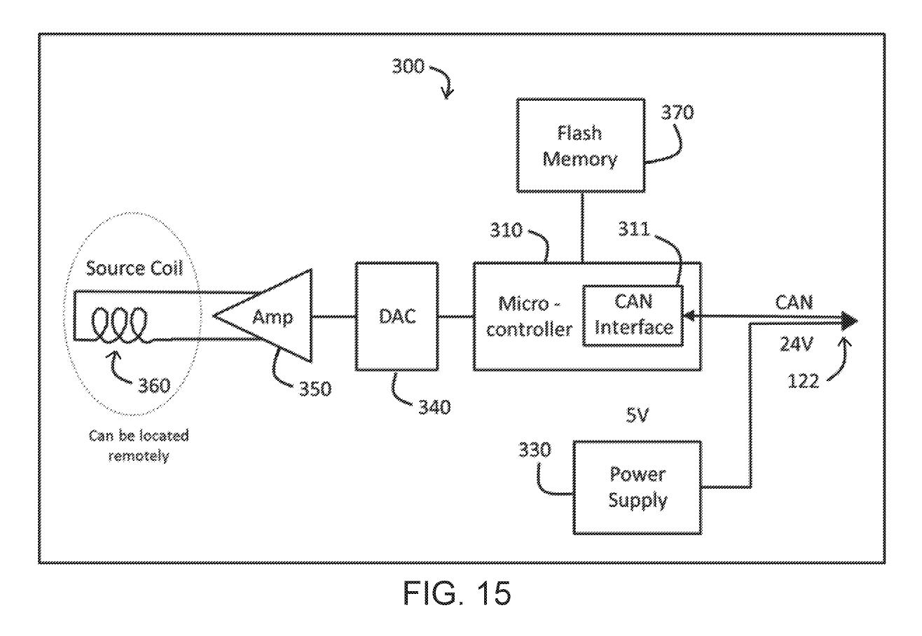

As shown in FIG. 15, the sound module 300 may include a microcontroller 310 with an embedded communication interface 311, such as a CAN interface, that communicates over the communication/power bus 122. A power supply 330 regulates the voltage supplied by the communication/power bus 122 (e.g., 24V) to the voltage required by the electronics (e.g., 5V). In response to commands received over the communication interface 311, the microcontroller 310 retrieves the specified sound from a memory 370, for example a flash memory, and outputs a digitized sound stream to a digital-to-analog converter (DAC) 340. The output from the DAC 340 is amplified by an amplifier (Amp) 350 that drives the source coil 360 located in the wearable components 110. Storing the sound files in the memory 370 reduces the need to stream the sound data over the communication interface 311 which could occupy significant bandwidth over the interface and take processing resources from the interface processor 121. With the sound files stored in the memory 370, the microcontroller 310 can handle sound generation based on commands received over the communication/power bus 122. Alternatively, a higher bandwidth interface and more capable processor could be utilized allowing the sound data to be streamed.

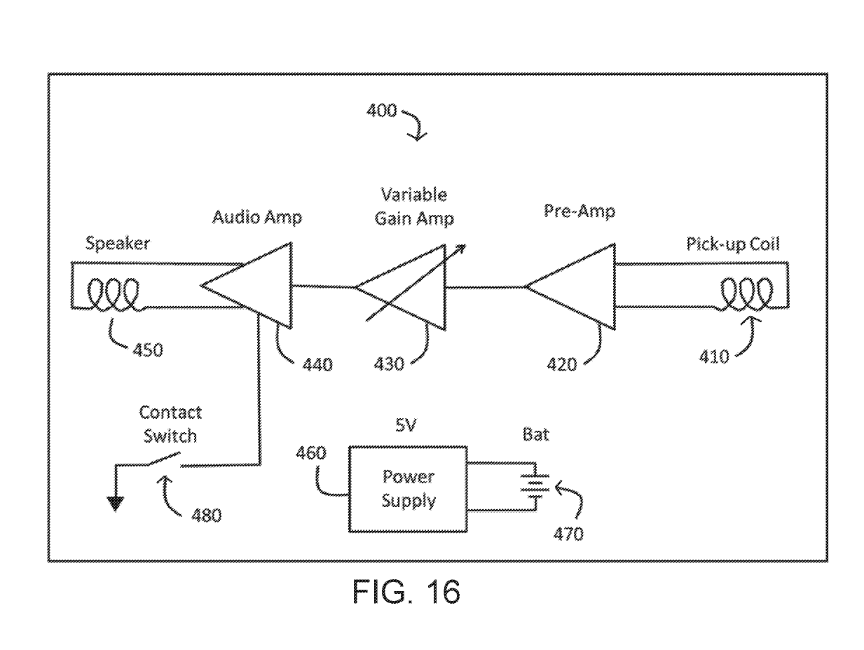

As shown in FIG. 16, the stethoscope module 400 may include a pre-amplifier 420 that amplifies and filters the signal from a pick-up coil 410. The output of the pre-amplifier 420 goes to a variable gain amplifier 430 that further amplifies the signal and provides a user gain control. In some embodiments, the variable gain amplifier 430 is eliminated. The signal then goes to an audio amplifier 440 that drives a speaker 450. The speaker 450 may be coupled to the bell of the stethoscope 401 allowing the trainee to hear the sound picked up by the pick-up coil 410. Increasing the volume using the variable gain amplifier 430 allows the sound generated by speaker 450 to be heard without the use of a stethoscope 401 allowing a group of trainees to hear the sound simultaneously. A contact switch 480 is closed when the stethoscope module 400 is brought in contact with the wearable components 110 and is connected to the enable line that is enabled when grounded, of the audio amplifier 440. Use of the contact switch 480 inhibits sound from being generated when the stethoscope module 400 is held directly over the source coil 360, but not in contact with the wearable components 110. Stethoscopes 401 require contact with a patient to operate which is duplicated in the body sound simulation using the contact switch 480. The electronics in stethoscope module 400 can be powered by a battery, for example, or by a power supply that runs off a battery.

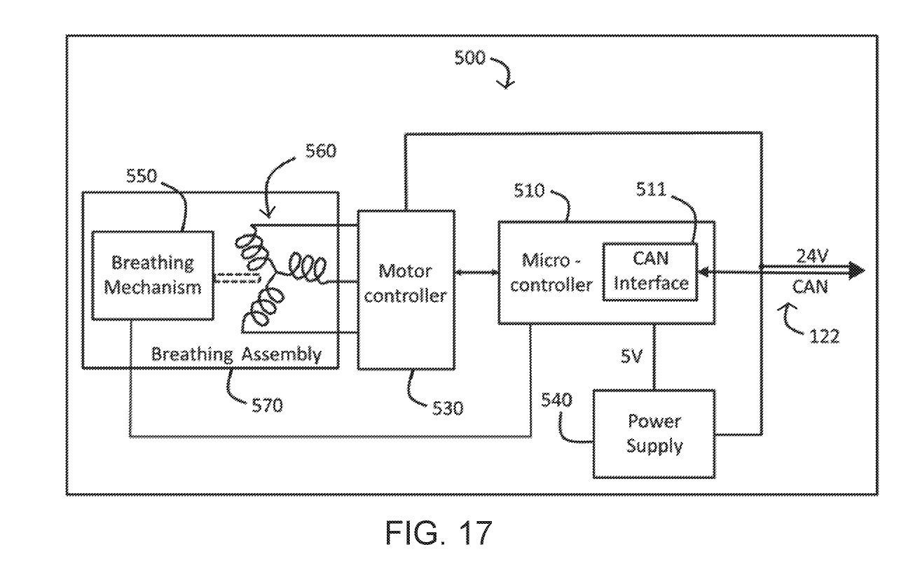

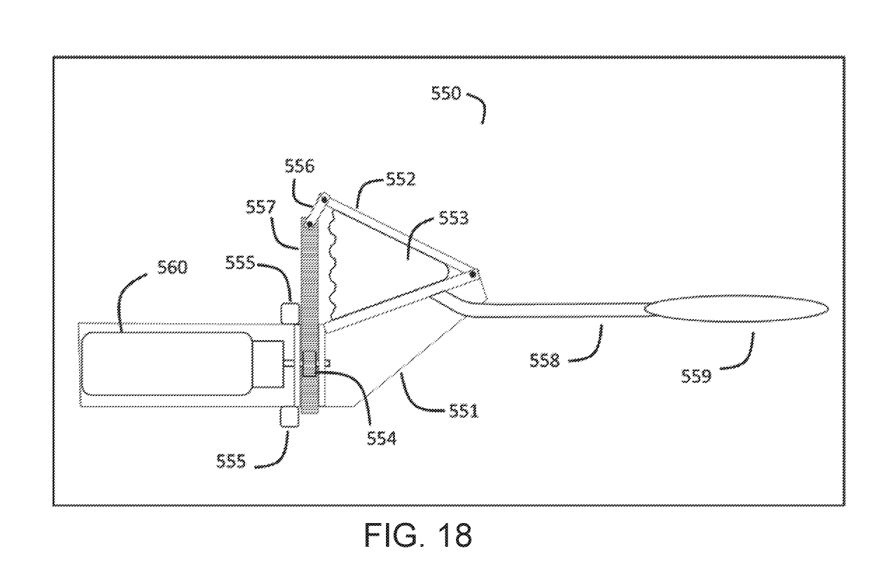

As shown in FIG. 17, a breathing module 500 includes a microcontroller 510 with an embedded CAN interface 511 that communicates over the communication/power bus 122. A power supply 540 regulates the voltage supplied by the communication/power bus 122 (e.g., 24V) to the voltage required for microcontroller 510 (e.g., 5V). In response to commands received over the CAN interface 511, the microcontroller 510 may drive a motor controller 530 to actuate a breathing assembly 570. The breathing assembly 570 may include a motor 560 that actuates a breathing mechanism 550 which in turn generates breathing motion in the wearable components 110.

As shown in FIG. 11, the motor 560 may be attached to a frame 551 such that the shaft of the motor 560 passes through a guide in the frame 551 capturing a rack 557 under a pinion gear 554. The rack 557 may be attached to a lever 552 with a pivot 556. The opposite end of the lever 552 may hinge on the frame 551. Bellows 553 may be located between the frame 551 and the lever 552. Operating the motor 560 results in the rack 557 sliding in or out of the frame 551 which causes the lever 552 to compress or expand the bellows 553. Switches 555 may provide feedback on the position of the rack 557 to the microcontroller 510 which controls motor the 560. Compressing the bellows 553 may cause air to pass through a tubing 558 into a bladder 559. Expanding the bellows 553 may cause air to be drawn through the tubing 558 from the bladder 559. The bladder 559 may be located in the wearable components 110 such that expansion and contraction of bladder the 559 results in motion that simulates breathing. In some embodiments, simulation of breathing motion may be done directly with the bladder 559. In other embodiments, the bladder 559 may operate a mechanism (e.g., breast plate) that creates the breathing motion. Another embodiment may be to use a piston mechanism in place of the bladder 559 and/or the bellows 553.

When the breathing mechanism 550 is used with a standardized patient, the bladder 559 and any associated mechanism (e.g., breast plate) that creates the breathing motion would be placed over the standardized patient's front torso area where natural breathing motion occurs.

As shown in FIG. 19, an isolation component 600 may be included to inhibit the trainee from feeling or seeing the standardized patient's natural breathing motion. The isolation component 600 is placed between the bladder 559 and/or any other mechanism that creates the breathing motion and the standardized patient's front torso area. The isolation component 600 may be in the form of an arch that rises above the standardized patient's front torso area only contacting the sides of the standardized patient's torso. This configuration allows the standardized patient's natural breathing motion to occur under the arch. The isolation component 600 also serves to isolate the breathing motion created by the breathing mechanism 550 from startling the standardized patient and makes the system more comfortable for the standardized patient. An arch shape may also allow air to flow under the isolation component 282 providing cooling.

The isolation component 600 is utilized to isolate the standardized patient's natural physiology (e.g., breathing motion, pulses) from the wearable simulation components and to isolate the wearable simulation components characteristics (e.g., heat, vibration) from the standardized patient. The isolation component 600 may utilize a thin, light outer shell 604 to which a soft foam 608 is attached. The soft foam 608 may be highly compliant and may have channels 612 to further aid compliance and to provide ventilation for the standardized patient. The standardized patient's motion may be absorbed by the soft foam 608 compressing between the standardized patient and the outer shell 604.

In another embodiment shown in FIG. 20, an isolation component 616 may use a self-supporting outer shell 620 that creates a gap 624 between wearable simulation components and the standardized patient. The outer shell 620 may contact the standardized patient with contact pads 628 that may contact the standardized patient at locations that are not significantly impacted by the standardized patient's natural physiology (e.g., breathing motion, pulses) or the wearable simulation components characteristics (e.g., heat, vibration).

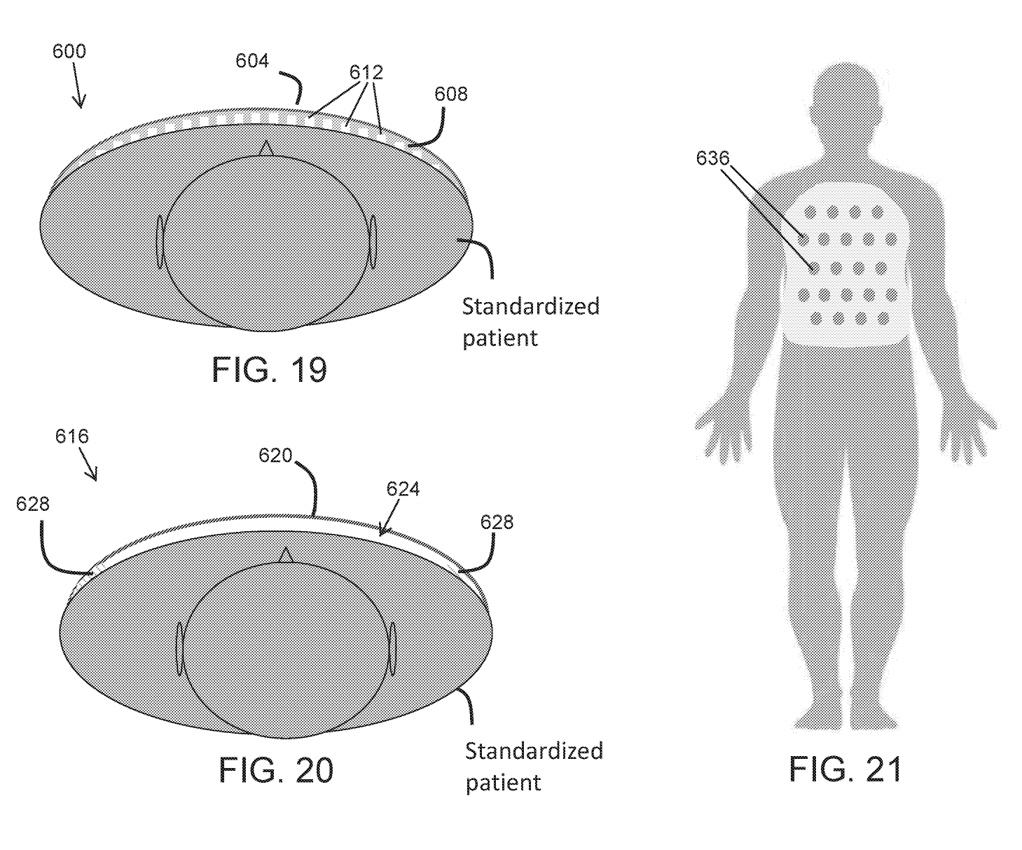

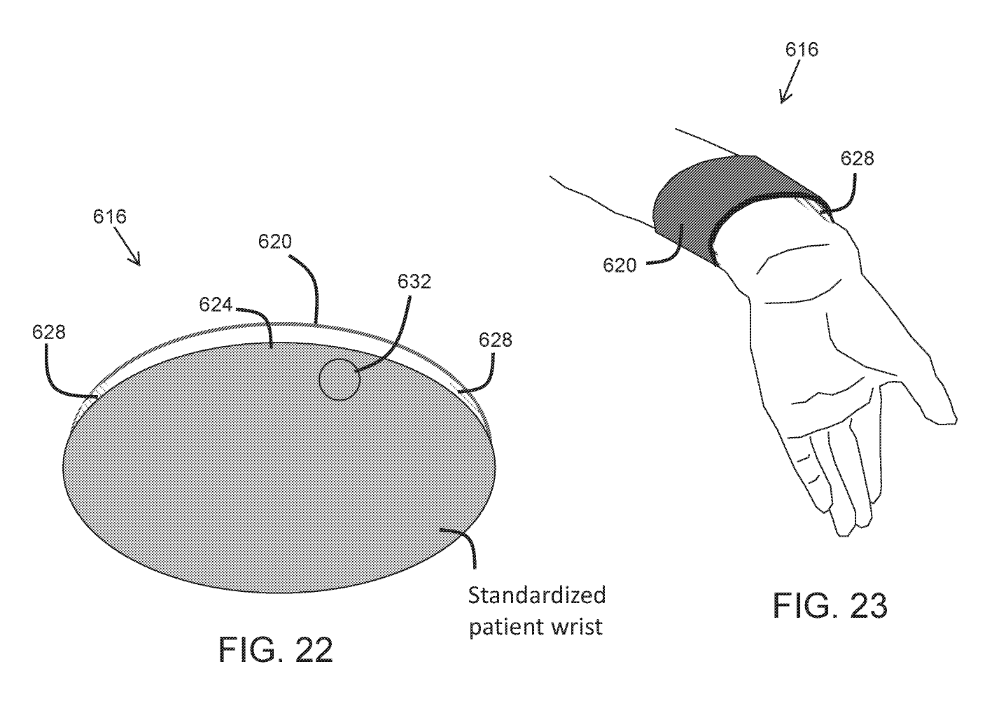

The isolation component 600, 616 may be in the form of a chest plate as shown in FIGS. 19 and 20, a wrist guard as shown in FIG. 22, or other form as needed. For example, as shown in FIG. 22, the isolation component 616 can isolate the wearable components 110 from the pulse present in an artery 632 of the standardized patient. The isolation component 600, 616 may also utilize openings or cutouts 636 in the outer shell 604, 620 to further aid ventilation as shown in FIG. 21. The isolation component 600, 616 may be secured to the standardized patient with a strap (not shown), by adhesive, by a body suit containing the wearable simulation components, or by other suitable means.

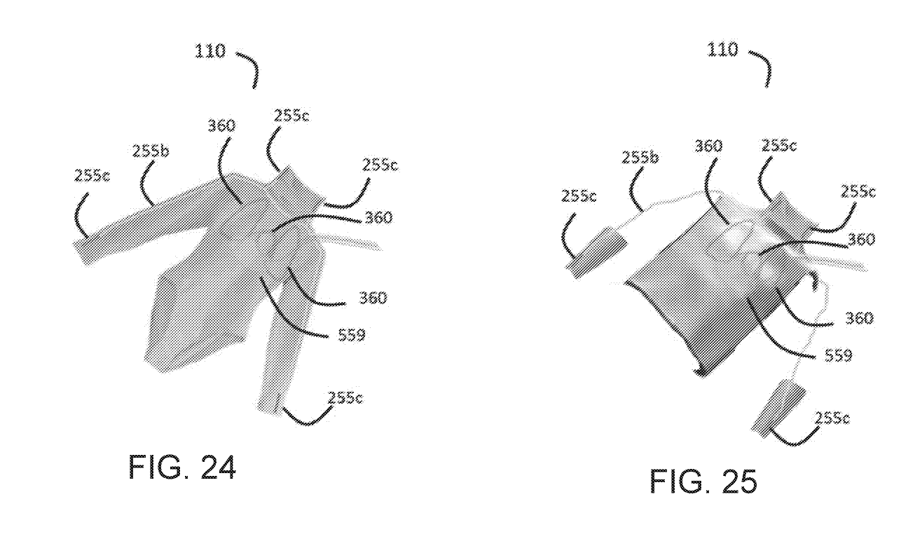

The above described features and components may be implemented into and be located in the wearable components 110. For example, as shown in FIGS. 24 and 25, these components include source coils 360, part of the pulse bladder assemblies 255 (e.g., bladder sections 255b and 255c), and part of the breathing mechanism 550 (e.g., tubing 558 and bladder 559). The pulse bladder sections 255b, 255c may be connected in series, however, the pulse bladder sections 255b, 255c may be separate if, for example, independent control is desired. The remaining components not located in the wearable components 110 may be located in the interface module 120. In other embodiments, the components may be distributed differently between the wearable components 110 and the interface module 120. Likewise, the wearable components 110 can be implemented in a variety of forms. For example, as shown in FIGS. 24 and 25, the wearable components 110 may resemble a body suit (see FIG. 24) or the wearable components may be implemented as arm cuffs and a chest plate (see FIG. 25). Other forms are also possible.

Other features, not detailed here, could be incorporated into the simulation system 100 with wearable components 110 thereby enhancing the system's utility. These features include, for example, eyewear that incorporates a mechanism or display to simulate blinking, eye motion, and/or pupil dilation. Voice functionality may also be implemented for use with a manikin where a trainer can speak into a remote microphone and his/her voice is heard at the manikin utilizing a speaker. Further, a private communication link may be implemented between a trainer and a simulated patient where the trainer can provide voice instructions to the simulated patient from a remote microphone with the instructions heard by the simulated patient through an ear bud.

The present disclosure has been described in terms of one or more preferred embodiments, and it should be appreciated that many equivalents, alternatives, variations, and modifications, aside from those expressly stated, are possible and within the scope of the disclosure.

1. A medical simulation system, comprising:
at least one wearable component;
an interface module coupled to the at least one wearable component, the interface module including an interface processor;
at least one hardware module coupled to the interface module, the at least one hardware module including a hardware processor in communication with the interface processor to provide functionality to the at least one wearable component, at least one vital sign can be simulated by the at least one hardware module; and
an isolation component configured to be arranged between the at least one wearable component and a standardized patient to isolate the standardized patient from the wearable component and to isolate the wearable component from the standardized patient.

2. The medical simulation system of claim 1, further comprising a communication bus and a power source coupled to the interface module, the communication bus configured to provide communication between the at least one hardware module and the interface processor, and the power source configured to power the at least one hardware module when power is required by the at least one hardware module.

3. The medical simulation system of claim 2, wherein the communication bus includes at least one of a wired and wireless network that utilizes at least one of a parallel digital communication technique and a series digital communication technique.

4. The medical simulation system of claim 2, wherein the communication bus is a multi-drop bus configured to couple to the at least one hardware module.

5. The medical simulation system of claim 2, wherein the at least one hardware module is a pulse module configured to simulate a pulse, the pulse module including:
a microcontroller coupled to a communication interface and configured to communicate over the communication bus; and
a circuit controlled by the microcontroller to actuate a pulse assembly.

6. The medical simulation system of claim 5, wherein the pulse assembly includes a pulse mechanism that is actuated by a solenoid to generate a palpable pulse.

7. The medical simulation system of claim 6, wherein the pulse assembly further includes:
a frame coupled to a body of the solenoid;
an actuator coupled to the solenoid;
a bladder assembly coupled to the frame and engaging the actuator, the bladder assembly including a first bladder section and a second bladder section partially filled with a fluid; and
wherein when the solenoid is energized, a force is exerted on the actuator causing the actuator to compress the first bladder section of the bladder assembly and forcing the fluid into the second bladder section of the bladder assembly, thereby expanding the second bladder section to create the pulse.

8. The medical simulation system of claim 7, wherein the first bladder section and the second bladder section are constructed of at least one of a flexible and compliant material.

9. The medical simulation system of claim 5, wherein the pulse assembly includes a pulse mechanism that is actuated by a vibration motor.

10. The medical simulation system of claim 9, wherein the vibration motor includes a first vibration motor and a second vibration motor arranged at opposite ends of a dummy tube.

11. The medical simulation system of claim 5, wherein the pulse assembly is activated by a touch sensor.

12. The medical simulation system of claim 2, wherein the at least one hardware module is a body sound module configured to simulate at least one body sound, the body sound module including:
at least one source coil positioned within the at least one wearable component;
a microcontroller coupled to a communication interface and configured to communicate over the communication bus;
a memory including at least one audio signal accessible by the microcontroller;
a digital-to-analog converter coupled to an amplifier configured to activate the at least one source coil and generate an analog output; and
wherein the microcontroller receives the at least one audio signal and outputs a digitized sound stream to the digital-to-analog converter, the analog output of the digital-to-analog converter amplified by the amplifier to activate the at least one source coil to simulate at least one audio of body sounds.

13. The medical simulation system of claim 12, wherein the body sound module is configured to interact with a stethoscope module, the stethoscope module including:
an amplifier circuit configured to at least one of amplify and filter a signal received from a receiving coil, the amplifier circuit being coupled to a speaker that generates at least one body sound; and
wherein the speaker is at least one of coupled to a bell end piece of a stethoscope and replaces the bell end piece of the stethoscope, allowing a user to hear the at least one body sound generated by the signal received from the receiving coil.

14. The medical simulation system of claim 13, wherein the stethoscope module further includes a contact switch, the contact switch configured to close when the stethoscope module contacts the at least one wearable component to generate the at least one body sound.

15. The medical simulation system of claim 14, wherein the contact switch is configured to open when the stethoscope module is positioned over a source coil, free of contact with the at least one wearable component, such that the at least one body sound is not generated.

16. The medical simulation system of claim 12, wherein the at least one source coil is constructed of a copper magnet wire and is dimensioned to outline an organ on the at least one wearable component, the organ including at least one of a heart, bowels, and lungs.

17. The medical simulation system of claim 12, wherein the at least one body sound includes at least one of lung sounds, heart sounds, and bowel sounds.

18. The medical simulation system of claim 1, further comprising at least one of a display and a control panel coupled to the interface module, wherein when the medical simulation system is automatically configured, controls are available to the control panel and physiologic data of the at least one wearable component is provided on the display.

19. The medical simulation system of claim 1, wherein the at least one wearable component includes at least one of a body suit, an arm cuff and a chest plate.

20. The medical simulation system of claim 1, wherein the isolation component includes a rigid outer shell that defines a gap configured to separate the wearable component from the standardized patient.

21-26. (canceled)
